(19) United States
(12) Patent Application Publication
(10) Pub. No.: US 2006/0008072 A1
(43) Pub. Date: Jan. 12, 2006

(54) Telephony system and method

(76) Inventor: Yaron Zutler, Hagor (IL)

Correspondence Address: YARON ZUTLER, P.O. BOX 77, HAGOR, IL

(21) Appl. No.: 10/885,063

(22) Filed: Jul. 7, 2004

(51) Int. Cl. H04M 3/00; H04M 5/00

(52) U.S. Cl. 379/266.01; 379/265.02

(57) ABSTRACT

An answering phone calls system, including means for implementing waiting options for the caller, in case it is not possible to answer the phone at that moment. The caller can choose between waiting on the queue, or asking the system to call him/her back, when only a short time will be left to wait. The caller can choose between a long queue and a short queue, wherein: a. in the short queue, each conversation is time limited, the waiting time in this queue is usually smaller, and the caller will usually get a faster response, when the caller does get answered, a limited service time will be available for the conversation, after which the caller will be automatically disconnected; b. whereas in the long queue, each conversation is not limited by time, however waiting time to get answered could be longer.

### FIELD OF THE INVENTION

This invention relates to a telephone exchange system and method, and more particularly to improvements in a private branch exchange (PBX).

### BACKGROUND OF THE INVENTION

Many companies and organizations now use telephone exchange systems which provide automatic voice answering and calls switching services or other telephony services which include an option to put the other side on hold. Music or a fixed message may be played to the caller while he waits. Such systems will be herein referred to as improved PBX, or PBX (private branch exchange).

On many occasions today, when a person initiates a telephone conversation to a place where a PBX is in use, the caller has to wait on the line before receiving the required service.

During the time the caller waits on line for the service, annoying music is often played by the PBX, the delay in the response is unpleasant. To add insult to injury, the caller has to pay for the phone bill for the waiting period. Not to mention the total loss of precious time for the caller.

The current situation is undesirable, not only for the caller but also for the receiving side: companies or organizations which employ a PBX can lose business, since they might lose many customers who give up the call and hang up the phone.

Thus, a firm may miss many business opportunities.

There is a need to improve the level of customer service offered by such systems.

The PBX systems in use today do not ask the user whether only a short conversation or just a simple answer is required, for instance.

A person calling to a company using a PBX must remain be occupied with the phone and wait on the queue, without the option to replace the handset or do anything else, because that person has to be ready for the moment when the callee would grant him the favor of an answer.

In most cases, the caller does not know how much waiting time is required, or how many people are waiting on line before him/her, and in all cases the caller does not know the exact waiting time to be expected.

### SUMMARY OF THE INVENTION

The present disclosure relates to improvements and new features in PBX systems.

A. When the caller is asked to wait on the phone for service, two possibilities will be made available to him/her:

1. The caller can wait in a queue dedicated to short conversations, each conversation being time limited. The waiting time in this line is shorter, and the caller will get a faster response.

When the caller does get answered, a limited service time will be allocated to the conversation accordingly, after which time the caller will be automatically disconnected. This time limitation can be set by the PBX operator at any time.

The operator can increase the time limitation during the conversation as well.

This option will be herein referred as: “short queue”.

2. The caller can wait in a queue which is not time-limited for each conversation, however waiting time to get answered could be longer.

This option will be referred as: “long queue”.

B. After selecting one of the two abovementioned possibilities, two more options are given to the caller:

1. Wait on line, be it a short or a long queue, until reaching that caller's turn.

While waiting, the caller can choose different options from an interactive menu, which the PBX will offer.

These options may include: Changing and controlling music playing, receiving information about estimated time to get the service, having quizzes and other games, etc. This option will be hereinafter referred as: “queue waiting”.

2. Hang up the phone and be thus released to do other tasks, picking up the phone only when his/her turn for receiving service has arrived.

Although hanging up the phone, the caller is still advancing in the queue. This can be managed by the PBX, without the need for the phone line to be kept active, thus saving the caller the phone bills for waiting time.

When a caller's turn is expected to arrive shortly, or has arrived already, the PBX would call back the caller, possibly using a special ring tone so as to indicate to the caller that the PBX is calling back.

If the caller answers the phone, the waiting time would be much smaller if any, because at that time only a small, fixed number of other callers are before the caller in the queue.

The fixed number of other callers before the caller may be preset and changed by the PBX's operator.

If the caller does not pick up the phone, he/she will be automatically deleted from the queue.

This option will be hereinafter referred as: “free waiting”.

The abovementioned possibilities: short or long queue and queue waiting or free waiting, will be referred to as: “put OnHold”, thus the user waits, on-line or off-line, and enjoys new features with a better service.

Further objects, advantages and other features of the hereby presented invention will become obvious to those skilled in the art upon reading the disclosure set forth hereinafter.

### BRIEF DESCRIPTION OF THE DRAWINGS

FIG. 1 illustrates general new PBX system configuration.

FIG. 2 illustrates the OnHold Manager and the Conversation Manager.

FIG. 3 illustrates internal parts of the new PBX system.

FIG. 4 illustrates a flow chart of a method for handling phone calls.

### DETAILED DESCRIPTION OF THE PREFERRED EMBODIMENTS

A preferred embodiment of the present invention will now be described by way of example and with reference to the accompanying drawings.

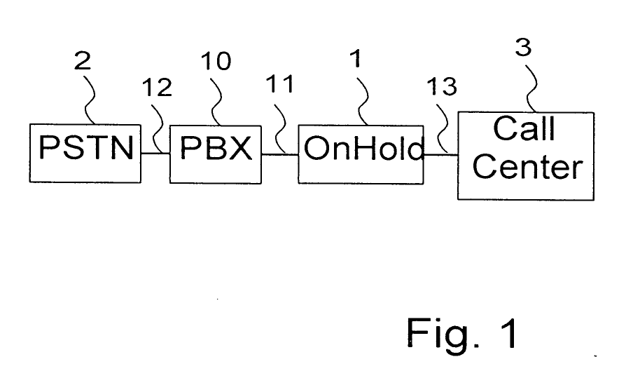

FIG. 1 illustrates the general new PBX system configuration.

The PBX system 10 is connected to PSTN 2, PSTN meaning Public Switched Telephone Network—this is the outside external telephone system.

The PBX is connected to PSTN by regular phone lines 12.

The OnHold means 1 is responsible for answering the call, routing the call to a call center agent 3, deciding and controlling the mode for each conversation, such as short or long queue status and queue waiting or free waiting possibilities.

The OnHold monitors conversations and also accepts commands from call center.

The OnHold may be within the PBX 10 which will be a new PBX system, or external, as illustrated, connected through channel 11 which can be implemented by any kind of data and/or control lines. Thus, the new PBX system may be implemented by connecting OnHold to a conventional PBX system.

The call center 3 is consisted of human call center agents, which can answer calls and also control the mode of conversation and other parameters.

Connection lines 13, are responsible for transferring: control Parameters and controlling commands from call center to OnHold, status of the PBX system to call center, status of the OnHold system to call center, switching the call lines to the agents.

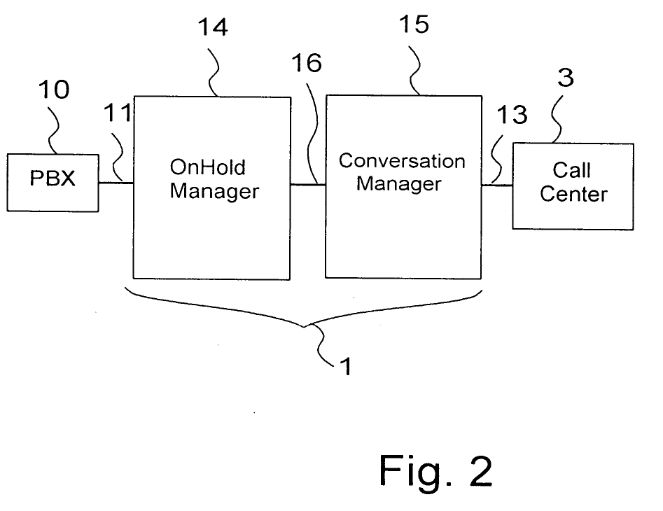

FIG. 2 illustrates possible implementation of the OnHold 1 by two systems: the OnHold Manager 14 and the Conversation Manager 15.

The OnHold Manager is responsible for answering the call, routing the call to a call center agent 3, deciding, controlling and asking caller for the mode of the conversation: short or long queue and queue waiting or free waiting.

The OnHold Manager controls when and whether to put OnHold or route to call center.

The OnHold Manager decides which call will be serviced next.

The OnHold manager manages FIFOs and queues, which keep the data regarding the callers. “FIFO” or “fifo” here refers to a “first in first out” memory means as known in the art.

The Conversation Manager connects calls to call center agents, notifies the OnHold manager when a call ends, limits the call time when needed and record a call when needed.

The Conversation Manager connects calls to call center agents through connections 13.

The Conversation Manager notifies the OnHold manager when a call ends and transfers commands coming from call center through lines 16.

The Conversation Manager accepts commands and calls through lines 16.

The OnHold manager and Conversation Manager may be within the PBX 10 which will be a new PBX system, or external, as in the figure, connected through 11 which can be implemented by any kind of data and/or control lines.

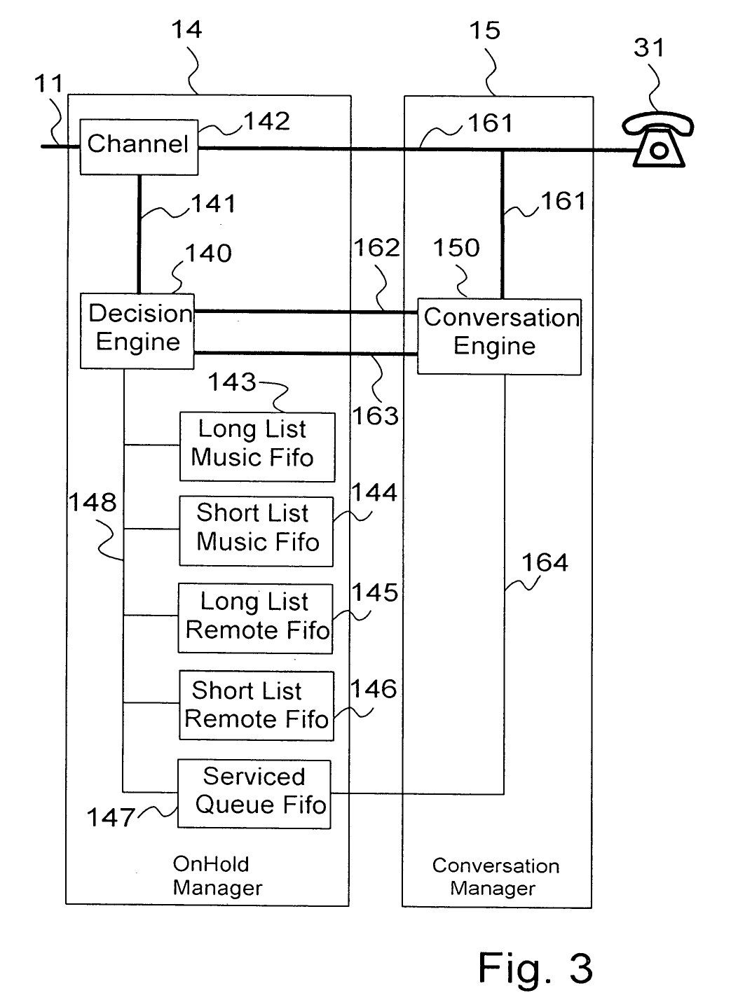

FIG. 3 describes internal parts of the Conversation Manager and the OnHold manager.

When a call is received on one of lines 11, to the PBX, it is connected to a channel 142, which is within the OnHold Manager 14.

There may be many channels at the PBX, each one can control the session in several ways: accept a conversation, answer the call and play a message or music, inform the system and the call center that a conversation has arrived, disconnect the conversation and any other operation.

A decision engine 140 is managing the channels, through lines 141, according to the information coming from the channels, through line 141, and the status of the system such as parameters set by operators, and the status of fifos: 143,144,145 and 146.

A conversation engine 150 is monitoring the conversations, which are being answered, through call lines 161, and can disconnect the conversation if it reaches a time limit set by the decision engine.

The conversation engine may record the conversation if it is required, this can be set by defining criteria for recording, or by sending a command through lines 163 from the decision engine.

The conversation engine informs the decision engine through 162, when the call has ended, so that other conversation can be accessed.

When a call is received and connected to a channel, the channel informs the decision engine through lines 141, about the conversation. The decision engine then checks if there is a free line to the call center.

In case there is a free line to call center, the line is switched through the conversation manager, on line 161, to connect a human agent 31 at call center.

In case there is not a free line to call center, the decision engine informs the channel, through line 141, that there is no free line.

The channel asks the user for the modes of conversation, such as short or long queue, queue waiting or free waiting possibilities.

The channel informs the Decision Engine about the chosen mode of operation. The decision engine can then update the status of the user in the relevant fifo:

If the user chooses long queue and queue waiting, data will be written to fifo 143.

If the user chooses short queue and queue waiting, data will be written to fifo 144.

If the user chooses long queue and free waiting, data will be written to fifo 145.

If the user chooses short queue and free waiting, data will be written to fifo 146.

The data will include details about the caller and the location in the relevant queue. In the free-waiting fifos, the details about each caller will include the phone number that the caller was requested to type as the phone number he/she can be reached at, when he/she had chosen the free waiting option.

Data will be written and read through lines 148 which connect between the fifos and the decision engine.

The decision engine can also control future user's requests and control music played by the channel. all of these operations are done through lines 141.

The OnHold monitors conversations and also accepts commands from call center.

A serviced queue fifo 147 keeps an updated list of users to serve. Users are added by the decision engine, through line 148. The type of service is also kept in this fifo, in order to let the conversation engine know how to monitor each channel (recording, for example).

Users are removed by the conversation engine, which also write for each channel the reason for which the conversation ended, for example: caller exceeded time limit or call hanged up the phone. These details are sent from conversation engine to the serviced queue fifo, through line 164.

The decision engine constantly checks the fifos.

The decision engine constantly calculates when is the turn of a new caller. When it is estimated that according to data in one of the free waiting fifos (145,146) there are 40 seconds (or any other time, as configured by the user) left before next user should be answered, The decision engine commands a channel to initiate a call to that user.

If a call in a channel which is registered at one of the queue-waiting fifos (143,144) was hanged up, then the decision engine commands the channel to disconnect that conversation. The conversation engine is updated by the decision engine as well, so that a new caller may be connected instead. If a caller that was waiting in one of the queue-waiting fifos has disconnected the call before his turn to be serviced had arrived, then the decision engine will delete this caller from the fifo.

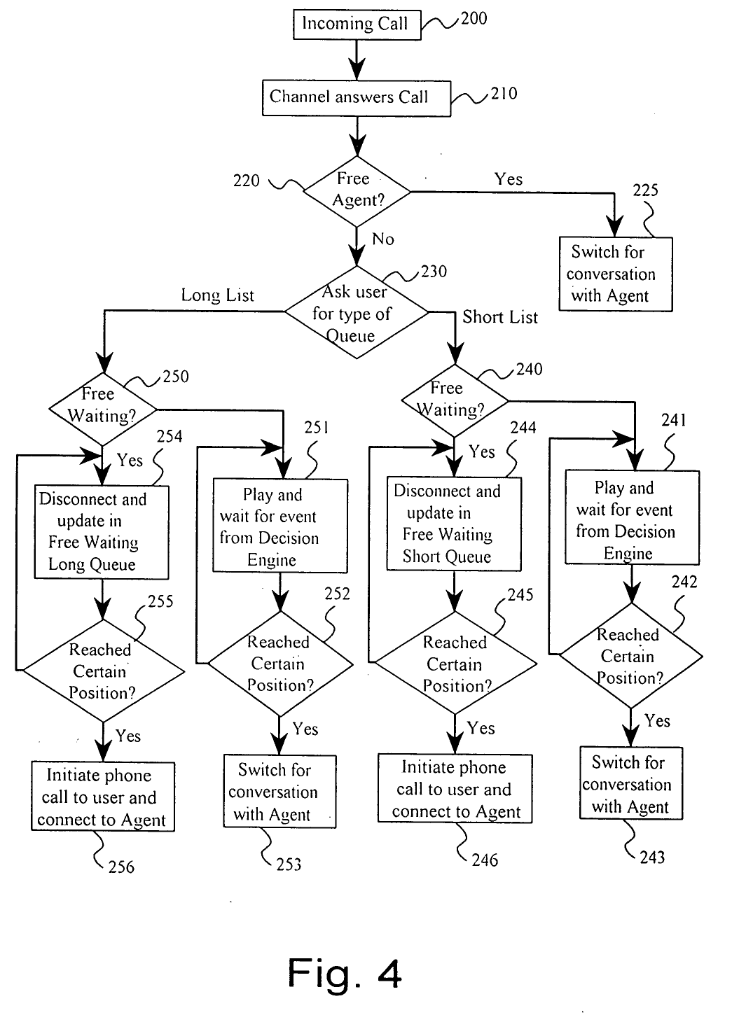

FIG. 4 describes a method for handling incoming telephone calls

An incoming call 200 is arriving through a regular telephone line or through a PBX, a channel answers that call 210, the function of the channel is as previously described. If there is a free human agent who can answer that phone call then it will be answered 225. If there is no free human agent who can answer that phone call, then the caller will be told that waiting is required, and then caller will be put OnHold.

In this case, the caller will be asked to choose between two options 230: waiting in the short queue, or waiting in the long queue. In both cases, the caller will be asked to choose between queue waiting and free waiting 240, 250.

If the caller selected “No” in 240 or 250, that is short or long queue waiting respectively, then the caller can choose while waiting, from interactive options 241,251 for short and long queue waiting, respectively.

These options may include: changing and controlling music playing if at all, receiving information about estimated time to get the service, having quizzes and other games, choosing a radio station to listen to, etc.

If the caller selected free waiting, short or long, that is “Yes” in 240 or 250 respectively, then the caller will be asked to type the phone number where he/she can be reached, and then the caller may hang up the phone and be free to doing other things, picking up the phone only when his/her turn for accepting service has arrived or when it is soon to arrive. the specific decision, 245 for short line or 255 for long line, when to call the client can be based on algorithmic decision, time estimation and operator's commands.

In all of these possible choices the caller is advancing along in the queue, however each possibility has different queue.

If the caller chooses a short/long queue waiting, then when the caller is first in the line he/she will access the agent at the call center. This is implemented by 242, 252 for short or long queue waiting, respectively.

A Caller's Status and position may be monitored by the system at 241, 242, 244, 245 and at 251, 252, 254, 255. In all such cases, time to service estimation is available. if the caller is in short queue, a more precise time to service estimation is available, since each caller has a limited time service.

If the caller chooses a short/long free waiting, then when the caller is at a predefined position in the queue, and based on other parameters such as number of agents handling this queue, the system will initiate a phone call to that caller, so that only a reduced waiting time will remain.

Eventually, a conversation with human agent is made 243, 246, 253, 256. The conversation is monitored and can be recorded or disconnected by decision.

The system and any of its functions and/or components may be implemented by software and/or by hardware means, as known in the art.

What is claimed is:

1. An answering phone calls system comprising means for implementing at least two waiting options for a caller, in case it is not possible to answer the phone at that moment.

2. The answering phone calls system according to claim 1, further including means for allowing the caller to choose between waiting on the queue, or asking the system to call him/her back, when only a short waiting time remains.

3. The answering phone calls system according to claim 1, further including means for allowing the caller to choose between a long queue and a short queue, wherein:
a. in the short queue, each conversation is time limited, the waiting time in this queue is usually smaller, and the caller will usually get a faster response, and when the caller does get answered, a limited service time will be available for the conversation, after which the caller will be automatically disconnected;
b. in the long queue, each conversation is not time limited, however waiting time to get answered could be longer.

4. The answering phone calls system according to claim 2, further including means for allowing the caller to choose between a long queue and a short queue, wherein:
a. in the short queue, each conversation is time limited, the waiting time in this queue is smaller and the caller will get a faster response, when the caller does get answered, a limited service time will be available for the conversation, after which the caller will be automatically disconnected;
b. in the long queue, each conversation is not limited by time, however waiting time to get answered could be longer.

5. The answering phone calls system according to claim 4, wherein each caller is monitored by the system, allowing each caller to choose a preferred music, ask about estimated remaining time to wait and/or enjoy other interactive options.

6. An answering phone calls method, comprising:
a. answering incoming phone calls and allocating a channel to each call;
b. checking if a free human agent can answer each phone call;
c. if it is not possible to answer a phone call, allowing the user to choose from two or more queue waiting options, wherein one waiting option comprises for the caller to hang up and for the system to call back to the caller later on, another option comprises waiting in a queue where each caller is limited on time of human service;
d. if the caller waits on queue, then the caller will be able to choose from interactive options, and hear relevant information and/or preferred music;
e. when and if the caller is connected to a human agent, it may be for a fixed time, after which the conversation can be disconnected, provided this is a short queue where each caller is limited in time;
f. the conversation can be monitored, recorded and disconnected according to a priori decisions.
